(19) United States
(12) Patent Application Publication
(10) Pub. No.: US 2014/0024335 A1
(43) Pub. Date: Jan. 23, 2014

(54) Methods for collecting usage information of portable devices, and utilizing methods and platforms thereof

(71) Applicants: Jason Hung, Taoyuan County (TW); Scott Shih, New Taipei City (TW)

(72) Inventors: Jason Hung, Taoyuan County (TW); Scott Shih, New Taipei City (TW)

(73) Assignee: CHIDOPI CO., LTD., Taipei City (TW)

(21) Appl. No.: 13/550,597

(22) Filed: Jul. 17, 2012

(51) Int. Cl. H04W 24/00

(52) U.S. Cl. 455/405

(57) ABSTRACT

A method for collecting usage information of portable devices is provided, wherein the method is performed by at least one server, and includes following steps: (A) providing an application to be downloaded by a device, wherein the application returns a used page message to the at least one server when the device is executed, and the content of the used page message includes identification data of the device, application software which is currently used and operated, a currently used page, environment parameters, and at least one of operational actions on the used page and a retention time on the used page; (B) receiving the used page message from the device; and (C) storing the used page message. The information which users are really interested in can be collected in the present invention, thereby achieving the objective of dispatch accuracy for marketing messages.

### BACKGROUND OF THE INVENTION

1. Field of the Invention

The disclosure relates generally to information collection methods and platforms for portable devices, and more particularly, to methods and platforms for collecting usage information of portable devices.

2. Description of the Related Art

The mobile communication industry has been vigorously developed in recent ten years, and it is popular for user to connect to a network via a 3G network system or a Wi-Fi module by using a smart phone. In addition to smart phones, the mobile communication related devices may also include the most classical and popular iPad provided by the Apple® corporation, which can provide capabilities of web-pages browsing, e-mail message composing, photos viewing, movie playback, and e-book reading, and have a light and handy body, such that it can be easy to carry as a document.

Since this kind of portable devices has a communication capability, a smart phone for example, related vendors have used signals of position update, dialing, or roaming of the devices (smart phones) to collect users' position coordinates. These position coordinates are analyzed and filtered using some conditions, and then location based services (LBSs) are accordingly provided, where detailed technology is discussed in Taiwan Patent Application Laid-open No. 200948037.

However, the existed technology can only collect the position coordinates of the devices, and transmit the position coordinates to the related servers via a server dispatch module maintaining LBS related services of the corresponding regions, such that the servers can transmit messages, such as activity information of a department store to the clients. That is to say, in the existed technology, the vendor can only provide location-related activity information to the device. For example, when a vendor knows a user is within a range of 200 meters of a SOGO® department store, the vendor can provide promotion messages to the device of the user. However, the user may be only a passenger on a rapid transit system passing through the station which is close to the SOGO® department store, and the promotion messages are meaningless for the user. Consequently, the marketing behaviors performed using the existed technology may be ineffectively.

### BRIEF SUMMARY OF THE INVENTION

The objective of the present invention is to provide methods and platforms for collecting usage information of portable devices, wherein the collected information can accurately reflect the content which the user interested in, thereby providing appropriate services.

Another objective of the present invention is to provide methods and platforms for utilizing usage information of portable devices, thereby providing appropriate services based on the content which can reflect the user's interest.

A platform for collecting usage information of portable devices is provided, wherein the platform is constructed in at least one server, and comprises an application provision module, a used page message reception module, and a usage information database.

The application provision module provides an application to be downloaded by a device, wherein the application returns a used page message to the at least one server when the device is executed, and the content of the used page message includes identification data of the device, application software which is currently used and operated, a currently used page, and environment parameters.

The used page message reception module receives the used page message from the device. The used page message reception module stores the used page message in the usage information database.

A method for collecting usage information of portable devices is provided, wherein the method is performed by at least one server, and includes following steps:

(A) an application is provided to be downloaded by a device, wherein the application returns a used page message to the at least one server when the device is executed, and the content of the used page message includes identification data of the device, application software which is currently used and operated, a currently used page, and environment parameters.

Preferably, the application is preset with a trigger condition for generating a used page message. When the trigger condition is met, a used page message is generated and encrypted, and transmitted to the at least one server.

Preferably, the used page is one of a reading page of e-book software, a scene of game software, and a web-page on a browser. The content of the used page message further includes at least one of operational actions on the used page and a retention time on the used page. The environment parameters in the content of the used page message include the position coordinates, temperature, weather, date, and time.

(B) the used page message is received from the device.

(C) the used page message is stored.

A platform for utilizing usage information of portable devices is provided, wherein the platform is constructed in at least one server, and comprises a usage information database, a query module, and a service transmission module.

The usage information database stores respective used page messages for several devices, and the content of each used page message includes identification data of the device, application software which is currently used and operated, a currently used page, and environment parameters.

The query module receives a query condition in respect of the content of the used page message, and performs a comparison in the usage information database according to the query condition, to obtain at least one device which had used the used page.

The service transmission module transmits a message in respect of the used page to the device which had used the used page.

A method for utilizing usage information of portable devices is provided, wherein the method is performed by at least one server, and includes following steps:
(a) a usage information database is provided, wherein the usage information database stores respective used page messages for several devices, and the content of each used page message includes identification data of the device, application software which is currently used and operated, a currently used page, and environment parameters;
(b) a query condition in respect of the content of the used page message is received;
(c) a comparison is performed in the usage information database according to the query condition, to obtain at least one device which had used the used page; and
(d) a message in respect of the used page is transmitted to the device obtained in (c). Preferably, in step (d), the message and the identification data of a target device are packed and transmitted to a PUSH server, and the PUSH server seeks the device having the identification data from a device list registering a PUSH service, and transmits the message to the device.

The efficacy of the present invention can know the information which users really interested by collecting the information, such as a used page, operational actions on the used page and a retention time on the used page of the device, thereby performing subsequent marketing behaviors, and achieving the objective of dispatch accuracy for marketing messages.

Methods for collecting and utilizing usage information of portable devices may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a block diagram illustrating an embodiment of a system for collecting and utilizing usage information consisting of platforms for respectively collecting and utilizing usage information of portable devices of the invention;

FIG. 2 is a flowchart of an embodiment of the execution procedure of the platform for collecting usage information of portable devices of the invention; and

FIG. 3 is a flowchart of an embodiment of the execution procedure of the platform for utilizing usage information of portable devices of the invention.

### DETAILED DESCRIPTION OF THE INVENTION

Methods, systems, and platforms for collecting and/or utilizing usage information of portable devices are provided.

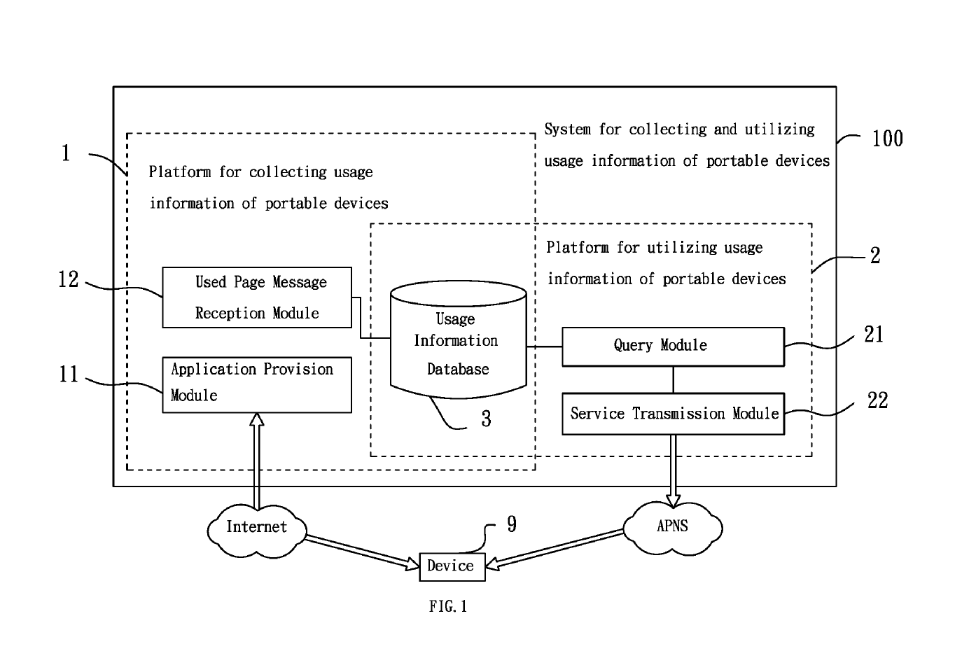

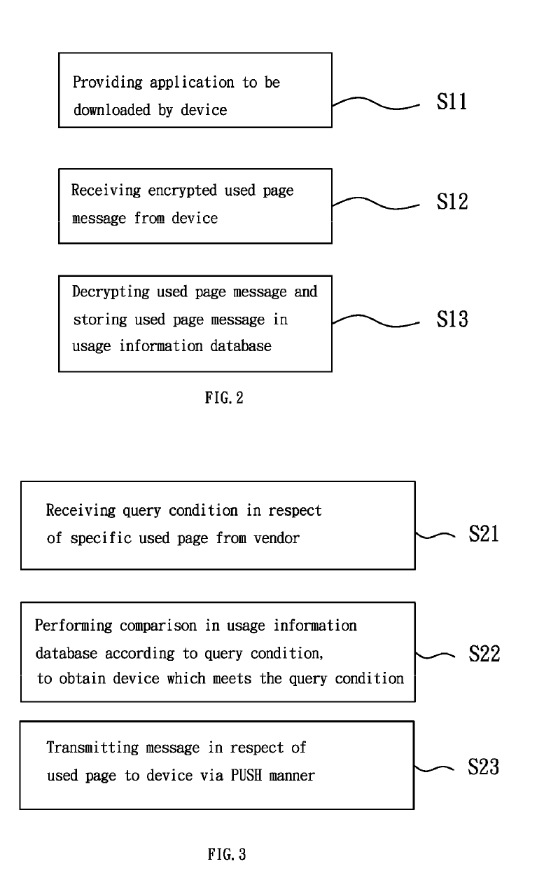

Referring to FIG. 1 and FIG. 2, the system for collecting and utilizing usage information of portable devices 100 is constructed in at least one server, wherein the system 100 comprises a platform for collecting usage information of portable devices 1, and a platform for utilizing usage information of portable devices 2, and the platforms 1 and 2 commonly have a usage information database 3.

In the preferred embodiment, the platform for collecting usage information of portable devices 1 comprises an application provision module 11, a used page message reception module 12, and a usage information database 3. The application provision module 11 provides an application to be downloaded by a device 9 (step S11), wherein the application encrypts a used page message and returns the used page message to at least one server via an Internet when the device 9 is executed. In the embodiment, the used page may be a reading page of e-book software, a scene of game software, and/or a web-page on a browser.

The transmission of the encrypted used page message by the above application may have an intelligent determination mechanism: if the device 9 is on-line, the encrypted used page message is immediately transmitted to the server; if the device 9 is off-line, the encrypted used page message is temporarily stored in the device 9, and re-transmitted to the server when the device 9 is on-line.

The used page message reception module 12 receives the encrypted used page message from the device 9 (step S12). The content of the used page message comprises identification data of the device 9, application software (ex., e-book software, game software or a browser) which is currently used and operated by the device 9, a currently used page, and environment parameters, and at least one of operational actions (ex., touching a specific object) on the used page and a retention time on the used page. The environment parameters may comprise the position coordinates, temperature, weather, date, and time. It is understood that, the present invention is not limited thereto, and the content of the parameters may be decreased or added. The used page message reception module 12 decrypts the used page message, and stores the used page message in the usage information database 3 (step S13).

Based on the present embodiment, when the user agrees the application provided by the application provision module 11, and then downloads and installs the application, the application will generate and transmit the user information to the used page message reception module 12.

For example, when a user uses the portable device (device 9) to read a specific periodical of an e-book magazine, and the retention time for a special topic or a specific page of advertisement belongs to a reasonable reading time, for example, the application presets a meaningfulness retention for a used page of an e-book as 5 seconds, the application triggers to generate a used page message after the 5 seconds retention on a specific used page, and encrypts and transmits the used page message to the used page message reception module 12. Therefore, the usage information database 3 can store the used page message. The stored used page message can be reasonably interpreted that the user interests in the special topic or the advertisement, and it is worth to transmit further messages in respect of the special topic or the advertisement to the device 9 by the platform for utilizing usage information of portable devices 2.

Further, for example, a user uses the portable device (device 9) to play a game, and a specific level cannot be surmounted. The application presets a trigger condition as a specific number of times of challenge failure or a time spent for challenge. If the trigger condition is met, the application triggers to generate a used page message, and encrypts and transmits the used page message to the used page message reception module 12. Therefore, the usage information database 3 can store the used page message. The stored used page message can be reasonably interpreted that the user needs related assistances of the specific level, and it is worth to transmit further messages in respect of the specific level to the user by the platform for utilizing usage information of portable devices 2.

Referring to FIG. 1 and FIG. 3, in the preferred embodiment, the platform for utilizing usage information of portable devices 2 comprises a usage information database 3, a query module 21, and a service transmission module 22. The query module 21 receives a query condition in respect of a specific used page (step S21), wherein the query condition is provided by a vendor, and performs a comparison in the usage information database 3 according to the query condition, to know which device 9 satisfying the query condition (step S22). The above query condition is relative to the content of the above used page message. The service transmission module 22 transmits a message in respect of the used page to the device 9 via a PUSH manner (step S23).

In detailed, the service transmission module 22 packs the message and the identification data of a target device 9, and then transmits the packed message to a PUSH server. For example, the device 9 may be a series product of Apple® computer, and the PUSH server is a server with Apple Push Notification Service (APNS). For example, the APNS server seeks the device 9 having the corresponding identification data from a device list registering a PUSH service, and transmits the message to the device 9. The device 9 passes the received push message to a push application, and the push application displays the message.

In the above e-book example, a vendor can provide an advertisement in the x-th page of an e-book magazine, and desire to know who will notice the advertisement among the readers of the e-book magazine. By the platform for utilizing usage information 2, the vendor can input a query condition, such as the x-th page of the e-book magazine (that is, the current used page in the content of the used page message), to know the reader group who interest in the advertisement, such that the service transmission module 22 can be enabled to transmit further messages pre-provided by the vendor to the devices 9 corresponding to the reader group via a PUSH manner.

In the above game software example, the game software vendor can input a query condition, such as the n-level of the game software (that is, the current used page in the content of the used page message) by the platform for utilizing usage information 2, to know the players who need related assistances in respect of the level, such that the service transmission module 22 can be enabled to transmit further messages (such as which treasure can be bought) pre-provided by the game software vendor to the devices 9 of the players via a PUSH manner.

Therefore, the platform for collecting usage information of portable device 1, the utilization platform 2, and the corresponding execution methods of the present invention can substantially improve the dispatch accuracy and effectiveness of marketing messages, thereby achieving the objective of the present invention.

Methods for collecting and utilizing usage information of portable devices, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for collecting usage information of portable devices, wherein the method is performed by at least one server, and the method comprises:
(A) providing an application to be downloaded by a device, wherein the application returns a used page message to the at least one server when the device is executed, and the content of the used page message comprises identification data of the device, application software which is currently used and operated, a currently used page, and environment parameters;
(B) receiving the used page message from the device; and
(C) storing the used page message.

2. The method of claim 1, wherein the application provided in step (A) presets a trigger condition for triggering to generate the used page message, and when the trigger condition is met, the used page message is generated and encrypted, and transmitted to the at least one server.

3. The method of claim 1, wherein the used page is one of a reading page of e-book software, a scene of game software, and a web-page on a browser.

4. The method of claim 1, wherein the content of the used page message further comprises at least one of operational actions on the used page and a retention time on the used page.

5. The method of claim 1, wherein the environment parameters in the content of the used page message comprise the position coordinates, temperature, weather, date, and time.

6. A method for utilizing usage information of portable devices, wherein the method is performed by at least one server, and the method comprises:
(a) providing a usage information database, wherein the usage information database stores respective used page messages for several devices, and the content of each used page message includes identification data of the device, application software which is currently used and operated, a currently used page, and environment parameters;
(b) receiving a query condition in respect of the content of the used page message;
(c) performing a comparison in the usage information database according to the query condition, to obtain at least one device which had used the used page; and
(d) transmitting a message in respect of the used page to the device obtained in step (c).

7. The method of claim 6, wherein the used page is one of a reading page of e-book software, a scene of game software, and a web-page on a browser, the content of the used page message further comprises at least one of operational actions on the used page and a retention time on the used page, and the environment parameters in the content of the used page message comprise the position coordinates, temperature, weather, date, and time.

8. The method of claim 6, wherein in step (d), the message and the identification data of a target device are packed and transmitted to a PUSH server, and the PUSH server seeks the device having the identification data from a device list registering a PUSH service, and transmits the message to the device.

9. A platform for collecting usage information of portable devices, wherein the platform is constructed in at least one server, and comprises:
an application provision module providing an application to be downloaded by a device, wherein the application returns a used page message to the at least one server when the device is executed, and the content of the used page message comprises identification data of the device, application software which is currently used and operated, a currently used page, and environment parameters;
a used page message reception module receiving the used page message from the device; and
a usage information database, wherein the used page message reception module stores the used page message in the usage information database.

10. The platform of claim 9, wherein the application presets a trigger condition for the used page message, and when the trigger condition is met, the used page message is generated and encrypted, and transmitted to the used page message reception module.

11. A platform for utilizing usage information of portable devices, wherein the platform is constructed in at least one server, and comprises:
a usage information database storing respective used page messages for several devices, and the content of each used page message includes identification data of the device, application software which is currently used and operated, a currently used page, and environment parameters;
a query module receiving a query condition in respect of the content of the used page message, and performing a comparison in the usage information database according to the query condition, to obtain at least one device which had used the used page; and
a service transmission module transmitting a message in respect of the used page to the device which had used the used page.

12. The platform of claim 11, wherein the service transmission module packs the message and the identification data of a target device, and transmits the message to a PUSH server, and the PUSH server seeks the device having the identification data from a device list registering a PUSH service, and transmits the message to the device.
